(19) United States
(12) Patent Application Publication
(10) Pub. No.: US 2007/0240935 A1
(43) Pub. Date: Oct. 18, 2007

(54) Ladder step attachment device

(76) Inventors: Richard O'Brien, Oxnard, CA (US); Holly O'Brien, Oxnard, CA (US)

Correspondence Address: EDWIN TARVER, 16830 Ventura Blvd., SUITE 360, Encino, CA, 91436, US

(21) Appl. No.: 11/375,872

(22) Filed: Mar. 14, 2006

(51) Int. Cl. E06C 7/16

(52) U.S. Cl. 182/120

(57) ABSTRACT

A device for mounting on a ladder to provide additional foot support comprising a horizontal plate-like member, a lip member projecting perpendicularly downwards from a first end of the rectangular plate-like member and a tubular member having a horizontal surface, a first substantially vertical surface, a second substantially vertical surface opposite to the first vertical surface, and an inclined surface. A second end of the rectangular plate-like member is attached to the trapezoidal tubular such that the rectangular plate-like member is parallel to and is in same plane as that of the horizontal surface.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to ladder step attachment devices, and more particularly to an improved ladder step attachment device that can be mounted on the rungs of a conventional extension ladder to provide additional foot support.

Ladder rungs, in general, are not sufficiently wide to provide a convenient foot support when standing for long periods of time. Painters, contractors, homeowners and others are frequently required to work for extended periods of time by standing on the rungs. Attachment devices that can be mounted on a ladder can provide a convenient platform for the ladder user. Such devices increase safety and may include simple, preferably single-step, installation procedures.

Several ladder step attachment devices have been developed in art. For example, U.S. Pub. No. 20040163890 to Nash discloses a ladder step platform that can be mounted on any ladder having hollow rungs extending between ladder rails. The device includes a step platform extending between side plates that are positioned on the outside of the ladder rails. The space between the side plates can be adjusted to fit ladders of different width. A support rod, inserts through the hollow rungs, and pivotally supports the ladder step platform with the side plates. A lower adjustable rod abuts the ladder rails such that the step platform extends horizontally beyond the ladder. Unfortunately, the installation means of this device, for example the use of the support and adjustable rods, are inconvenient and difficult to use.

U.S. Pat. No. 5,052,515 to Nowlan discloses a ladder attachment that comprises of a platform, a vertical support member projecting from one edge of the platform, and two brackets. An upper bracket is intended to engage a rung of the ladder to impart lateral stability to the platform, while a lower bracket is intended to cooperate with a second rung of the ladder to provide lateral and vertical stability to the platform. The need for two rungs for support and the structure of this device, especially the vertical member and the two brackets, makes it bulky and difficult to operate with a single hand.

U.S. Pat. No. 1,820,315 to Miller discloses a step attachment for ladders consisting of a step platform connected to a pair of transversely spaced metallic brackets and a transversely extending stop member. The metallic brackets have their upper ends formed to include hooks capable of being inserted over the rungs of the ladder. The horizontal feature of the metallic brackets are connected to the under surface of the step platform. Although the installation procedure appears to be similar, the hooks and the stop member of this device make it ineffective.

U.S. Pat. No. 6,786,300 to Bonifacini discloses a step unit that can be installed on the existing step of a conventional ladder. The unit comprises of a rectangular main body portion with one of its end bent downward and angularly outward with respect to the main body portion and terminates in a short upturned lip. The unit is installed by engaging the upturned lip against the bottom edge of the step and then pivoting the unit downwardly. The lip of the unit is then captured by the bottom edge of the step and the main body portion is supported on top of the step. However, the bent and upturned lip features of this device are different from the lip and the tubular members of the present invention.

Although these devices can be mounted on a ladder to provide additional foot support, they are frequently inconvenient to use, overly complex, or lack stability. Therefore, it is an object of the present invention is to provide an improved ladder step attachment device that is portable, simple and easy to install and uninstall, and strong enough to withstand the weight of a person. Other objects of the present invention will become better understood with reference to the appended summary, description, claims and illustrations.

### SUMMARY

The present invention is a ladder step attachment device that can be mounted on a rung of a ladder to provide additional foot support. The device comprises a unitary piece characterized by a horizontal rectangular plate-like member to support a user, a lip member to hook to the rung of a ladder, and a substantially trapezoidal tubular member to support the device against the rails of a ladder. The lip member projects downwards from a first end of the rectangular plate-like member. At the other end of the rectangular plate-like member, the trapezoidal tubular member comprises a horizontal surface, a first substantially vertical surface, a second substantially vertical surface opposite to the first vertical surface and an inclined surface.

In order to mount the device on a rung of a conventional extension ladder, the first vertical surface is made to abut the side rails of the ladder. Following which, the lip member is made to abut a side rear surface of one of the rungs and the bottom surface of the rectangular plate-like member is made to abut the top surface of the rung of the ladder. The top surface of the rectangular plate-like member provides a foot support area.

### BRIEF DESCRIPTION OF THE FIGURES

FIG. 1A is a perspective view of the ladder step attachment device in accordance with the present invention.

FIG. 1B is a perspective view of the ladder step attachment device in accordance with the present invention, wherein the side caps of the ladder step attachment are omitted.

FIG. 2A is a side view of the ladder step attachment device.

FIG. 2B is a side view of the ladder step attachment device, wherein the length of the top horizontal member is varied.

FIG. 2C is a side view of the ladder step attachment device in accordance with the present invention, wherein the side caps of the ladder step attachment are omitted.

FIGS. 3A and 3B illustrate perspective and side views of the ladder step attachment device in position prior to mounting to a rung of a ladder.

FIGS. 4A and 4B illustrate perspective and side views of the ladder step attachment device mounted to a rung of a ladder.

FIG. 5A is a perspective view of a mounted ladder step attachment device in use.

FIG. 5B is a perspective view of a mounted ladder step attachment device in use, wherein the side caps of the step attachment device are omitted.

### FIGURES—REFERENCE NUMERALS

10 . . . Ladder Step Attachment Device
11 . . . Extension of Rectangular Plate-like Member
12 . . . Lip Member
13 . . . Trapezoidal Tubular Member
14 . . . Area of elongation of Rectangular Plate-like Member
15 . . . Rectangular Plate-Like Member
16 . . . First Vertical Surface
17 . . . Second Vertical Surface
18 . . . Inclined Surface
19 . . . Lip Bend
20 . . . Side cap
21 . . . Rung
22 . . . Ladder
23 . . . Side Rail

### DETAILED DESCRIPTION

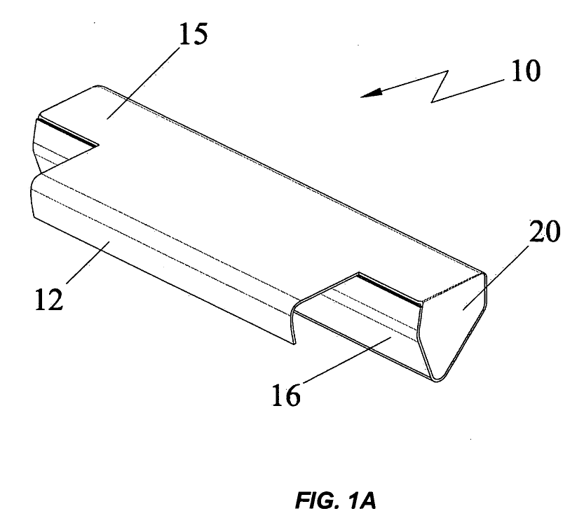

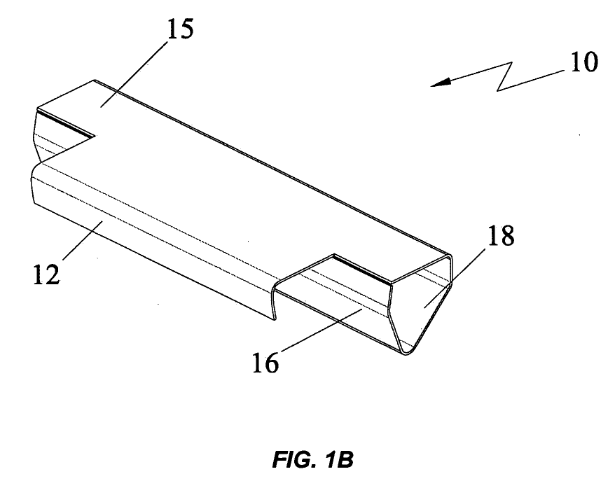

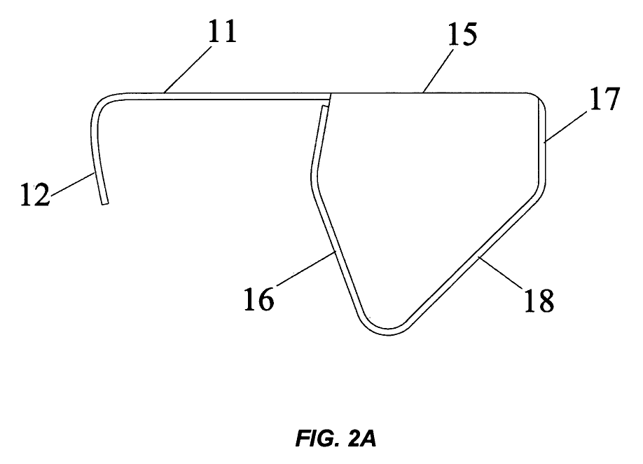

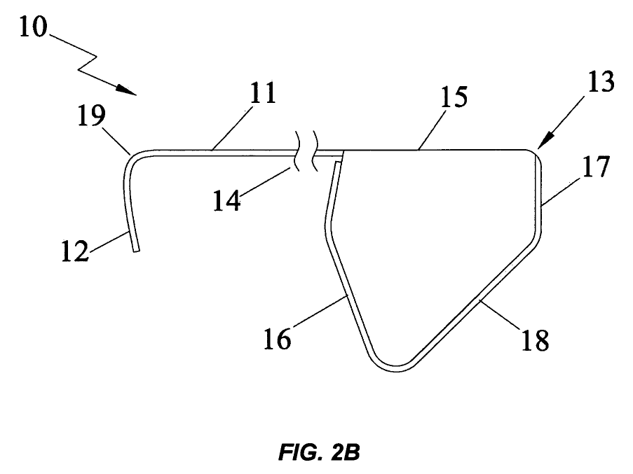

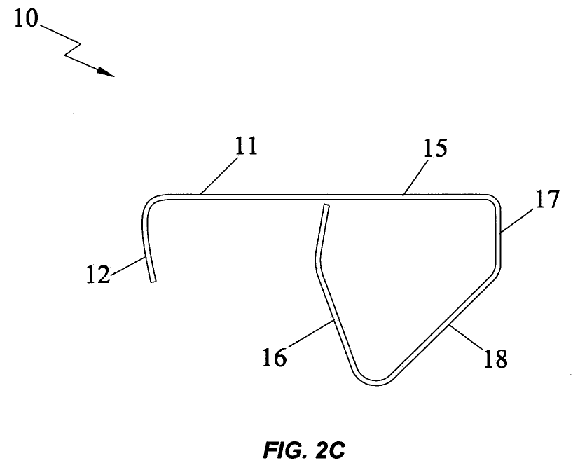

Referring to the drawings, a preferred embodiment of a ladder step attachment device is illustrated and generally indicated as 10 in FIGS. 1 through 5. The ladder step attachment 10 mainly comprises a horizontal rectangular plate-like member 15, a lip member 12 and a substantially trapezoidal tubular member 13. The lip member 12 projects perpendicularly downwards as seen in FIGS. 1 and 2. The widths of the rectangular member 15 and the lip member 12 can be received between side rails of a ladder.

Referring to FIGS. 1 and 2, the trapezoidal tubular member 13 includes a horizontal surface 15, a first substantially vertical surface 16 with a slightly inward bend parallel to the plane of the horizontal surface 15, a second substantially vertical surface 17 opposite to the first vertical surface 16, and an inclined surface 18. The end of the rectangular plate-like member 15 opposite the tubular member 13 comprises an extension of the rectangular plate-like member 11 terminating in a lip bend 19 and lip member 12. The extension of the rectangular plate-like member 11 is made narrower than the rectangular plate-like member 15 so that it fits between the side rails of a ladder. Two side caps 20 on opposite outer portions of the tubular member 13 cover the hollow portion of the trapezoidal tubular member 13. The side caps 20 provide additional strength to the trapezoidal tubular member 13.

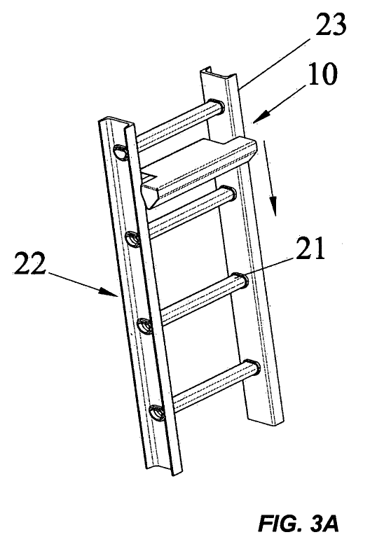

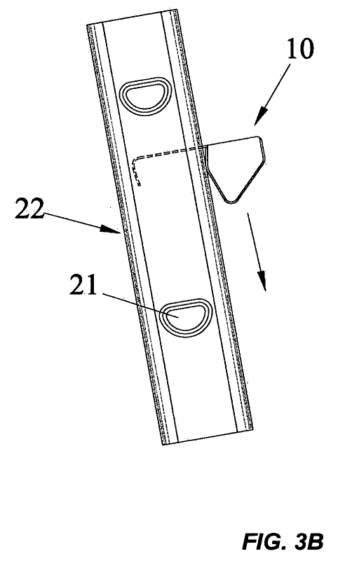

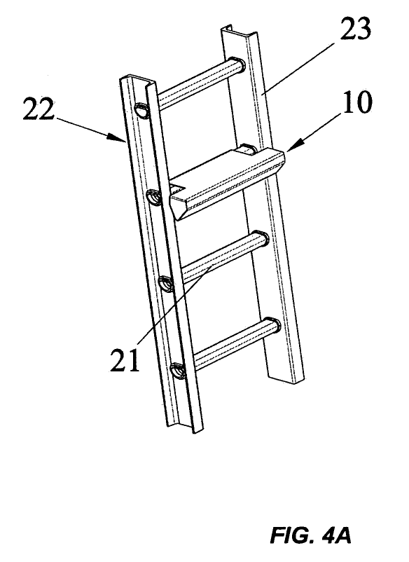

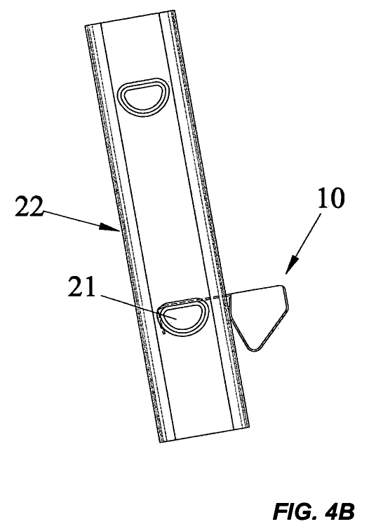

Referring to FIGS. 3 and 4, the procedure involved in mounting the ladder step attachment device 10 is explained herein. The device 10 is first positioned above any rung 21 on a ladder 22. The portion of the device including the lip member 12 and the rectangular plate-like member 11 is made to pass between the side rails 23 of the ladder 22 until the device 10 abuts the side rails 23 of the ladder, as seen in FIGS. 3A and 3B. The device 10 is then moved downwards until the lip member 12 comes into contact with the rear side surface of the rung 21, and bottom surface of the rectangular plate-like member 11 abuts a top surface of the rung 21.

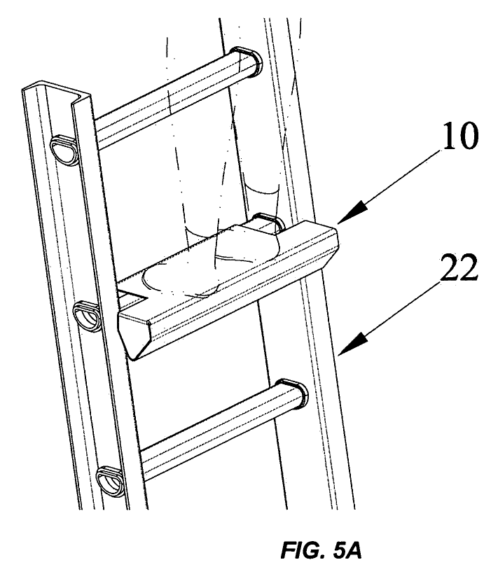

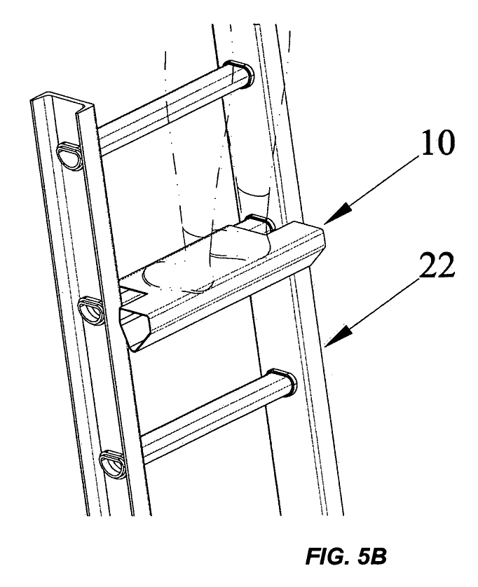

When the ladder step attachment device 10 is mounted on the rung 21 of the ladder 22, the top surface of the rectangular plate-like member 15 and its extension 11 provide additional foot support area. To remove the step attachment device, the tubular member 13 is moved upward along the sides of the ladder, and rotated along its horizontal axis, so that the lip member 12 can be freed from the rear of the ladder rung 21. The device 10 can be mounted, removed and remounted while standing on a ladder. An illustration of the ladder step attachment device 10 in use is shown in FIG. 5.

The ladder step attachment device can be made of any single sheet of metal cut to the appropriate shape and bent so as to form the lip member, horizontal surface, and tubular member of the device. In an alternate embodiment of the invention, the side caps are omitted, providing more flexibility to the device. Alternatively, the ladder step attachment device can be made of metal, plastic, resin, or any suitable strong lightweight material.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A portable, removable, unitary ladder step attachment for providing additional foot support, the ladder step attachment comprising;
a horizontal plate-like member having a first end and a second end along its length, a bottom surface of the plate-like member adapted to abut a top surface of a rung of the ladder;
a lip member projecting downward from the first end of the plate-like member, the lip member adapted to abut a side rear surface of a rung of a ladder; and
a substantially trapezoidal tubular member projecting downward from an opposite end of the plate-like member having;
a first substantially vertical surface;
a second substantially vertical surface opposite to the first vertical surface; and
an inclined surface; wherein
the end of the plate-like member opposite the lip member terminates at an edge formed by the intersection of the plate-like member and the second vertical surface of the tubular member, such that the tubular member depends downward and toward the ladder, allowing the first vertical surface of the tubular member to abut the rails of the ladder.

2. The ladder step attachment of claim 1, wherein the plate-like member and the lip member are of a dimension to be received between the rails of the ladder, and the trapezoidal tubular member is dimensioned to prevent it from being received between the rails of the ladder.

3. The ladder step attachment of claim 2, wherein the trapezoidal tubular member is wider than the lip member and the plate-like member matches the width of the lip member along its horizontal surface, until it reaches the intersection of the first vertical surface of the tubular member, wherein it matches the width of the tubular member.

4. The ladder step attachment of claim 1, wherein side caps are welded onto the opposing free ends of the tubular member to provide additional stiffness for the trapezoidal tubular member.

5. The ladder step attachment of claim 1, wherein top surfaces of the rectangular plate-like member and the horizontal surface provide additional foot support for the user when the ladder step attachment is installed on the rung of the ladder.

6. The ladder step attachment of claim 1, wherein the ladder step attachment can be made of metal, plastic, resin, or any suitable material that is lightweight and strong enough to support the weight of a person.

7. The ladder step attachment of claim 1, wherein the ladder step attachment includes rounded edges and corners.

8. A portable, removable, unitary ladder step attachment for providing additional foot support, the ladder step attachment comprising;
a horizontal plate-like member having a first end and a second end along its length,
a lip member projecting downward from the first end of the plate-like member, the lip member adapted to abut a side rear surface of a rung of a ladder; and
a substantially triangular tubular member having two inclined surfaces adjacent to the horizontal plate-like member, wherein the first inclined surface depends from the second end of the horizontal surface, and the second inclined surface depends upward from its connection to the first inclined surface and terminates at the bottom of the horizontal plate-like member.

9. The ladder step attachment of claim 8, wherein the horizontal plate-like member is of varying width, so that the first end of the horizontal plate-like member and the lip member are received between the rails of a ladder, and the triangular tubular member and second end of the horizontal plate-like member abuts the rails of the ladder.

10. The ladder step attachment of claim 9, wherein the triangular tubular member is wider than the rectangular plate-like member and the lip member, the wider portion of the horizontal plate-like member extends at a 90 degree angle from the narrower portion, such that the second end of the horizontal plate-like portion forms one side of the triangular tubular member.

11. The ladder step attachment of claim 8, wherein side caps are provided at the ends of the triangular tubular member.

12. The ladder step attachment of claim 8, wherein the top surface of the horizontal plate-like member provide additional foot support for the user when the ladder step attachment is installed on the rung of the ladder.

13. The ladder step attachment of claim 8, wherein the top surface of the horizontal plate-like member comprises a no-slip/non-skid surface feature.

14. The ladder step attachment of claim 8, wherein the ladder step attachment can be made of metal, plastic, resin, or any material lightweight and strong enough to support the weight of a person.

15. The ladder step attachment of claim 8, wherein the ladder step attachment includes rounded edges and corners.

16. The ladder step attachment of claim 1, wherein the second vertical surface comprises a member that depends from the horizontal plate-like member and terminates at an inclined surface, which depends still farther downward toward the rails of a ladder, terminating at a first vertical surface depending upward at an angle to make it parallel to the rails of a ladder across its bottom portion so that the ends of the first vertical surface contact the face of the ladder rails, and bent away from the rails of a ladder across its top portion, terminating just below the bottom surface of the horizontal plate-like member.

17. The ladder step attachment of claim 8, wherein the second vertical surface comprises a member that depends from the horizontal plate-like member and terminates at an inclined surface, which depends still farther downward toward the rails of a ladder, terminating at a first vertical surface depending upward at an angle to make it parallel to the rails of a ladder across its bottom portion so that the ends of the first vertical surface contact the face of the ladder rails, and bent away from the rails of a ladder across its top portion, terminating just below the bottom surface of the horizontal plate-like member.
